(19) United States
(12) Patent Application Publication
(10) Pub. No.: US 2025/0028280 A1
(43) Pub. Date: Jan. 23, 2025

(54) METHOD AND SYSTEM FOR FOVEATED HOLOGRAM RENDERING

(71) Applicant: Korea Electronics Technology Institute, Seongnam-si (KR)

(72) Inventors: Sung Hee HONG, Seoul (KR); Young Min KIM, Seoul (KR); Ji Soo HONG, Seoul (KR)

(73) Assignee: Korea Electronics Technology Institute, Seongnam-si (KR)

(21) Appl. No.: 18/713,728

(22) PCT Filed: Dec. 6, 2021
(86) PCT No.: PCT/KR2021/018316

§ 371 Date: May 28, 2024

(30) Foreign Application Priority Data
Dec. 6, 2021 (KR) 10-2021-0172555

(51) Int. Cl. G03H 1/08; G02B 27/01; G06F 3/01

(52) U.S. Cl. CPC G03H 1/08; G02B 27/0172; G06F 3/013; G02B 2027/0174; G03H 2226/05; G03H 2240/56

(57) ABSTRACT

A method and a system for foveated hologram rendering are provided. A method for foveated hologram rendering according to an embodiment of the present invention comprises: tracking a user's line of sight, rendering a hologram having a first resolution in the user's central line of sight, and rendering a hologram having a resolution lower than the first resolution in the user's peripheral line of sight. Accordingly, a hologram content with high quality and high resolution can be generated and reproduced at high speed through foveated hologram rendering in which holograms having different resolutions are rendered in the user's central line of sight and peripheral line of sight.

### TECHNICAL FIELD

The disclosure relates to a hologram-related technology, and more particularly, to a method for reproducing a foveated hologram through a holographic head mounted display (HMD) by rendering in real time.

### BACKGROUND ART

Rendering a computer-generated hologram (CGH) by using a point cloud is technically possible, but has a problem. FIG. 1 is a view illustrating a problem of a related-art hologram generation method.

As shown in the drawing, in a CGH using a point cloud, the number of points constituting an object increases as the hologram has a higher resolution, and the amount of computation also increases exponentially, and thus, it may be difficult to reproduce a hologram in real time.

Accordingly, there is a demand for a solution for reproducing a hologram by rendering in real time.

### DISCLOSURE

### Technical Problem

The disclosure has been developed in order to address the above-discussed deficiencies of the prior art, and an object of the disclosure is to provide a foveated hologram rendering method and system for rendering holograms having different resolutions in a foveal vision part and a peripheral vision part of a user, as a solution to generate and reproduce a hologram content with high quality, high resolution at high speed.

### Technical Solution

According to an embodiment of the disclosure to achieve the above-described object, a foveated hologram rendering method may include: a step of tracking a gaze of a user; a first rendering step of rendering a hologram of a first resolution in a foveal vision part of the user; and a second rendering step of rendering a hologram of a resolution lower than the first resolution in a peripheral vision part of the user.

The first rendering step may include rendering the hologram by using all of points in a point cloud of the foveal vision part.

The second rendering step may include rendering the hologram after reconstituting N points in a point cloud of the peripheral vision part as one point.

N may increase as points are farther away from the foveal vision part. N is settable by the user.

The second rendering step may include down-sampling color information of the reconstituted points.

A size of the foveal vision part is settable by the user.

According to another embodiment of the disclosure, a foveated hologram service method may include: a holographic head mounted display (HMD) configured to track a gaze of a user and to reproduce a received hologram content; and a rendering server configured to receive gaze information of the user from the holographic HMD, to render a hologram of a first resolution in a foveal vision part of the user, to render a hologram of a resolution lower than the first resolution in a peripheral vision part of the user, to create one hologram content by combining the rendered holograms, and to transmit the created hologram content to the holographic HMD.

### Advantageous Effects

As described above, according to embodiments of the disclosure, through foveated hologram rendering in which holograms having different resolutions are rendered in a foveal vision part and a peripheral vision part of a user, a hologram content with high quality and high resolution may be generated and reproduced at high speed.

In particular, according to embodiments of the disclosure, a hologram is rendered in the same way as the hologram is viewed by user's eyes, thus giving feeling close to reality a user, and a cost and time required to generate holograms may be reduced, and thus, it is possible to provide hologram services of various forms such as augmented reality by applying the method of the disclosure.

### DESCRIPTION OF DRAWINGS

FIG. 1 is a view illustrating a problem of a related-art hologram generation method;

FIG. 2 is a view illustrating a related-art hologram rendering method;

FIG. 3 is a view illustrating a foveal vision part and a peripheral vision part;

FIG. 4 is a view provided to explain a hologram rendering method in a peripheral vision part;

FIG. 5 is a view illustrating a configuration of a hologram virtual reality service system according to an embodiment of the disclosure;

FIG. 6 is a flowchart provided to explain a hologram virtual reality service method according to another embodiment of the disclosure.

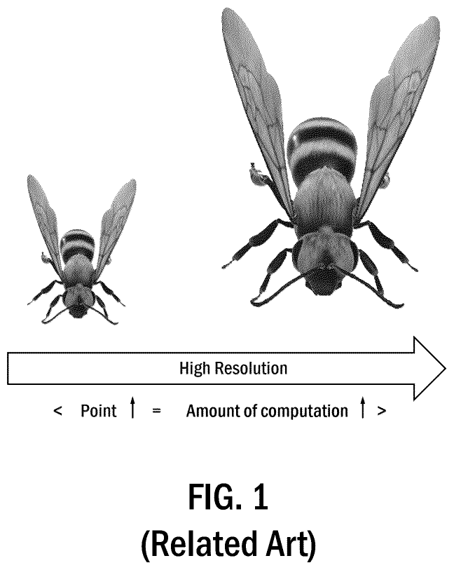

### BEST MODE

Hereinafter, the disclosure will be described in more detail with reference to the drawings.

Embodiments of the disclosure provide a foveated hologram rendering method. The disclosure relates to a rendering method which tracks user's (observer's) gaze, and renders a hologram with high quality in a foveal vision part that the user gazes at, and renders a hologram with low quality in the other part which is a peripheral vision part.

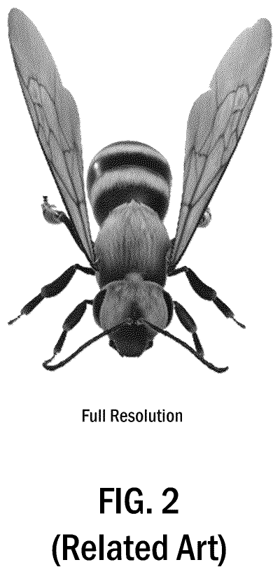

A related-art method of rendering a hologram for all points of a point cloud (FIG. 2) may have a problem that it is difficult to generate/reproduce a hologram in real time since there is a large amount of computation to process.

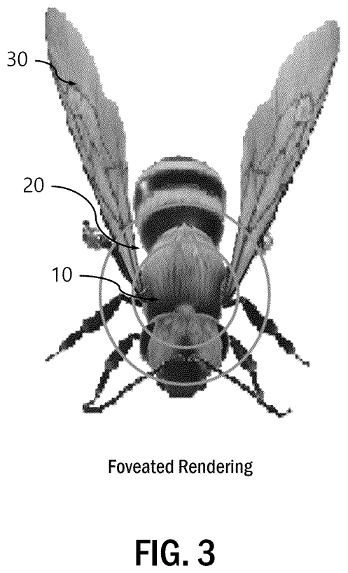

As shown in FIG. 3, a foveated hologram rendering method proposed in embodiments of the disclosure renders points of a foveal vision part 10, which is a part that a user gazes at, in the same way as a related-art method, and renders points of peripheral vision parts 20, 30 into a hologram with a low resolution, so that the amount of computation in the peripheral vision parts 20, 30 may be reduced and a hologram may be generated/reproduced in real time.

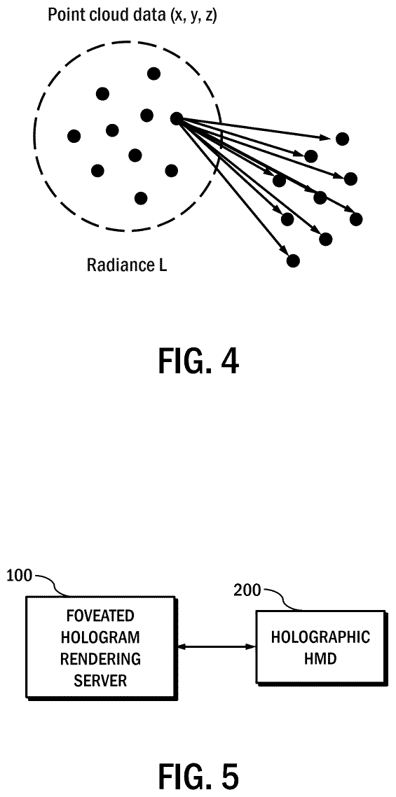

FIG. 4 is a view provided to explain a hologram rendering method in a peripheral vision part 20, 30. As shown in the drawing, a hologram is rendered after reducing data by grouping N points in the point cloud of the peripheral vision part as indicated by the dashed line and reconstituting as one point.

That is, in an embodiment of the disclosure, the point cloud may be reconstituted at a ratio of N:1, and then, the hologram may be rendered. This process may be a process of reconstituting coordinate vector information (x, y, z) of points as a new coordinate vector.

Here, N may be set to increase as points are farther away from the foveal vision part 10. That is, N of the peripheral vision part 30 may be greater than N in the peripheral vision part 20.

In FIG. 3, the peripheral vision part 20, 30 are divided into two parts, but more precisely, the peripheral vision part may be divided into three or more parts. Furthermore, N values in respective peripheral vision parts 12, 130 may be implemented to be set by a user.

In addition, the size of the foveal vision part 110 may be implemented to be set in consideration of user's own vision characteristics and taste, and quality of service (QoS).

Furthermore, data may further be reduced by down-sampling color (R, G, B) information of points reconstituted in the peripheral vision parts 20, 30.

FIG. 5 is a view illustrating a configuration of a hologram virtual reality service system according to an embodiment of the disclosure. The virtual reality service system according to an embodiment of the disclosure may include a foveated hologram rendering server 100 and a holographic head mounted display (HMD) 200 as shown in the drawing.

The foveated hologram rendering server 100 may determine a foveal vision and a peripheral vision based on user's gaze, and may render a hologram with a high resolution in the foveal vision part and may render a hologram with a low resolution in the peripheral vision part.

The holographic HMD 200 may be worn on user's head, and may track user's gaze and may transmit a result of tracking to the foveated hologram rendering server 100, and may receive a hologram content from the foveated hologram rendering server 100 and reproduce a hologram.

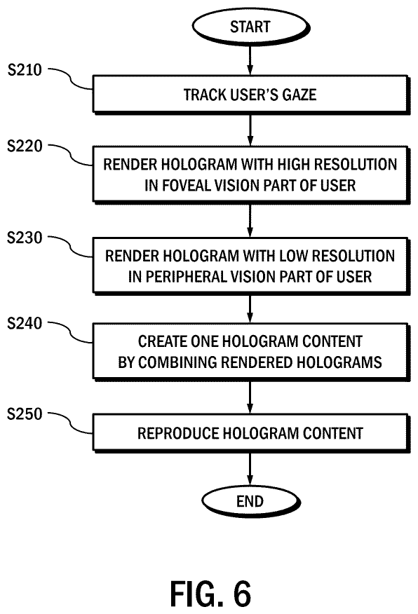

FIG. 6 is a flowchart provided to explain a hologram virtual reality service method according to another embodiment of the disclosure.

As shown in the drawing, the holographic HMD 200 that a user wears may track user's gaze by using an eye tracker such as an eye tracking sensor, and may transmit a result of tracking to the foveated hologram rendering server 100 (S210).

The foveated hologram rendering server 100 may render a hologram with a high resolution in a foveal vision part of the user (S220), and may render a hologram with a low resolution in a peripheral vision part of the user (S230).

The foveated hologram rendering server 100 may create one hologram content by combining the hologram of the foveal vision part rendered at step S220 and the hologram of the peripheral vision part rendered at step S230 (S240).

The foveated hologram rendering server 100 may transmit the hologram content created at step S240 to the holographic HMD 200, and the holographic HMD 200 may reproduce the received hologram content and may provide the same to the user (S250).

Up to now, a hologram virtual reality service method and system using foveated hologram rendering has been described in detail with reference to preferred embodiments.

Embodiments of the disclosure propose a rendering method which distinguishes a foveal vision and a periphery vision according to user's gaze and renders holograms with different resolutions so as to create a hologram content with high quality, high resolution at high speed.

According to foveated hologram rendering according to an embodiment of the disclosure, a hologram is rendered in the same way as the hologram is viewed by user's eyes, thus giving feeling close to reality the user, and a cost and time required to generate holograms may be reduced, and thus, it is possible to define hologram service models of various forms such as virtual reality, augmented reality by applying the method of the disclosure.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A foveated hologram rendering method comprising:
a step of tracking a gaze of a user;
a first rendering step of rendering a hologram of a first resolution in a foveal vision part of the user; and
a second rendering step of rendering a hologram of a resolution lower than the first resolution in a peripheral vision part of the user.

2. The foveated hologram rendering method of claim 1, wherein the first rendering step comprises rendering the hologram by using all of points in a point cloud of the foveal vision part.

3. The foveated hologram rendering method of claim 2, wherein the second rendering step comprises rendering the hologram after reconstituting N points in a point cloud of the peripheral vision part as one point.

4. The foveated hologram rendering method of claim 3, wherein N increases as points are farther away from the foveal vision part.

5. The foveated hologram rendering method of claim 3, wherein N is settable by the user.

6. The foveated hologram rendering method of claim 3, wherein the second rendering step comprises down-sampling color information of the reconstituted points.

7. The foveated hologram rendering method of claim 1, wherein a size of the foveal vision part is settable by the user.

8. A foveated hologram service method comprising:
a holographic head mounted display (HMD) configured to track a gaze of a user and to reproduce a received hologram content; and
a rendering server configured to receive gaze information of the user from the holographic HMD, to render a hologram of a first resolution in a foveal vision part of the user, to render a hologram of a resolution lower than the first resolution in a peripheral vision part of the user, to create one hologram content by combining the rendered holograms, and to transmit the created hologram content to the holographic HMD.
